(19) United States
(12) Patent Application Publication
(10) Pub. No.: US 2016/0281851 A1
(43) Pub. Date: Sep. 29, 2016

(54) SEALING FACE FOR A COMPONENT

(71) Applicant: Caterpillar Inc., Peoria, IL (US)

(72) Inventors: Eric E. Halla, Peoria, IL (US); Tony J. Fischer, Rapid City, SD (US); Brandon Shull, Peoria, IL (US)

(73) Assignee: Caterpillar Inc., Peoria, IL (US)

(21) Appl. No.: 14/669,708

(22) Filed: Mar. 26, 2015

(51) Int. Cl. F16J 15/06; F01M 11/00

(52) U.S. Cl. CPC F16J 15/062; F01M 11/0004; F01M 2011/0062

(57) ABSTRACT

A sealing face defined at a mating surface of a component is disclosed. The sealing face includes a first slant surface extending inwardly from a top edge of the mating surface to a first inner edge of the component. The first slant surface is disposed at a first angle with respect to the mating surface. The sealing face further includes a straight surface extending from the first slant surface. The straight surface is provided between the first inner edge and a second inner edge of the component. The sealing face further includes a second slant surface extending inwardly from the straight surface to an innermost edge of the component. The second slant surface is disposed at a second angle with respect to the straight surface.

### TECHNICAL FIELD

The present disclosure relates to a sealing assembly defined between two mating components, and more particularly relates to a sealing face provided on a mating surface of one of the mating components.

### BACKGROUND

Generally, a fluid containing or carrying member, such as an oil sump in an engine, may be made by coupling two or more components. The components are coupled to each other via fastening members. Further, a gasket sealant is disposed between mating surfaces of the components to provide a fluid tight coupling between the components. The fluid containing or carrying members may be exposed to high temperature and vibration depending on various applications. In an example, the oil sump of the engine may be formed by coupling an oil pan with a cylinder block of the engine. The oil pan is used for containing lubricating oil. The gasket sealant is provided between mating surfaces of the cylinder block and the oil pan for preventing leakage of the lubricating oil.

During coupling of the components by the fastening members, thickness of a film defined by the gasket sealant between two adjacent components may be relatively thin. Less quantity of the sealant may result in relatively weaker joints that may not be able to withstand surrounding environmental conditions. In the example of the oil sump, during operation of the engine, the cylinder block and the oil pan may undergo thermal expansion due to high temperature. Additionally, vibrations may cause damage of the gasket sealant film formed between the components.

US Published Application Number 2005/0285351 describes a seal structure. The seal structure includes an upper oil pan of an engine having a flange with an oil pan abutment surface that is fixedly coupled to a flange formed on a cylinder block. The oil pan abutment surface includes a flat portion that is substantially parallel to a cylinder block abutment surface of the cylinder block, a slanted portion that is slanted with respect to the flat portion, and a vertical wall portion connecting the flat portion and the slanted portion. The vertical wall portion is formed substantially perpendicular to the flat portion. The cylinder block and the upper oil pan are fixedly coupled together via an interposed liquid gasket. However, a space defined by the seal structure between the oil pan abutment surface and the cylinder block abutment surface may not be sufficient to allow thermal expansion of the oil pan and the cylinder block.

### SUMMARY OF THE DISCLOSURE

In one aspect of the present disclosure, a sealing face defined at a mating surface of a component is provided. The sealing face having a cross-section includes a first slant surface extending inwardly from a top edge of the mating surface to a first inner edge of the component. The first slant surface is disposed at a first angle with respect to the mating surface. The sealing face further includes a straight surface extending from the first slant surface. The straight surface is provided between the first inner edge and a second inner edge of the component. The sealing face further includes a second slant surface extending inwardly from the straight surface to an innermost edge of the component. The second slant surface is disposed at a second angle with respect to the straight surface.

In another aspect of the present disclosure, a sealing assembly defined between a first component and a second component is provided. The sealing assembly includes a mating surface defined on the first component. The sealing assembly further includes an abutment surface defined on the second component. The abutment surface is in a contacting relationship and coupled to the mating surface. The sealing assembly further includes a sealing face defined at the mating surface of the first component. The sealing face having a cross section includes a first slant surface extending inwardly from a top edge of the mating surface to a first inner edge of the first component. The first slant surface is disposed at a first angle with respect to the mating surface. The sealing face further includes a straight surface extending from the first slant surface. The straight surface is provided between the first inner edge and a second inner edge of the first component. The sealing face further includes a second slant surface extending inwardly from the straight surface to an innermost edge of the first component. The second slant surface is disposed at a second angle with respect to the straight surface. The sealing assembly further includes a sealant provided in a space defined between the first slant surface, the straight surface, the second slant surface, and the abutment surface.

In yet another aspect of the present disclosure, a sealing face for an oil pan is provided. The sealing face having a cross-section includes a first slant surface extending inwardly from a top edge of a mating surface of the oil pan to a first inner edge of the oil pan. The first slant surface is disposed at a first angle with respect to the mating surface. The sealing face further includes a straight surface extending from the first slant surface. The straight surface is provided between the first inner edge and a second inner edge of the oil pan. The sealing face further includes a second slant surface extending inwardly from the straight surface to an innermost edge of the oil pan. The second slant surface is disposed at a second angle with respect to the straight surface.

Other features and aspects of this disclosure will be apparent from the following description and the accompanying drawings.

### BRIEF DESCRIPTION OF THE DRAWINGS

FIG. 1 is a perspective view of an engine showing an oil pan, according to an embodiment of the present disclosure;

FIG. 2 is a perspective view of the oil pan, according to an embodiment of the present disclosure;

FIG. 3 is a sectional view of the oil pan taken along line A-A′ of FIG. 2, according to an embodiment of the present disclosure; and

FIG. 4 is a sectional view of a portion of a sealing assembly defined between the oil pan and a cylinder block of the engine, according to an embodiment of the present disclosure.

### DETAILED DESCRIPTION

Reference will now be made in detail to specific embodiments or features, examples of which are illustrated in the accompanying drawings. Wherever possible, corresponding or similar reference numbers will be used throughout the drawings to refer to the same or corresponding parts.

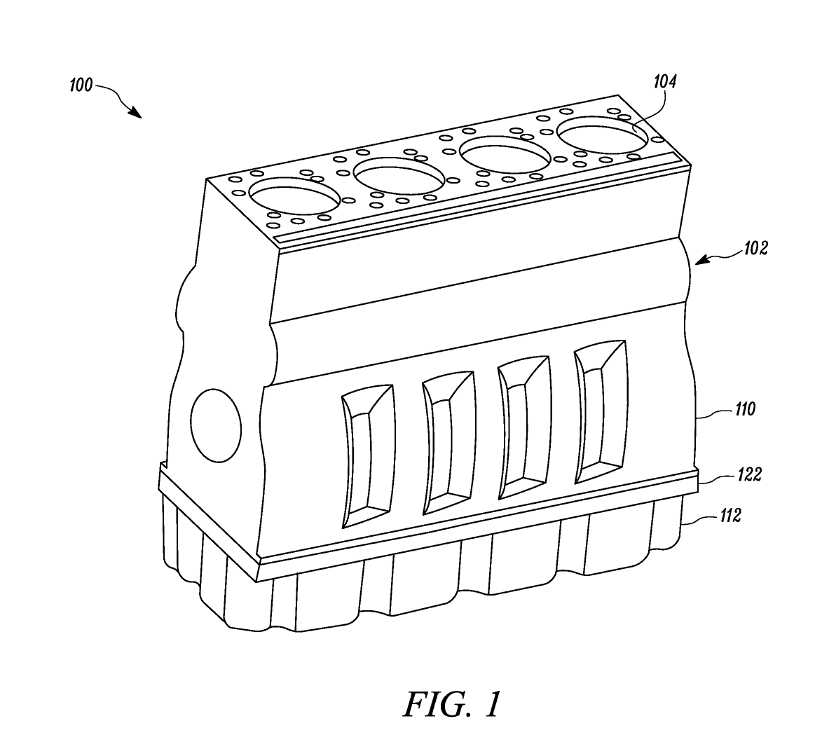

FIG. 1 illustrates a perspective view of an engine 100 used in machines, such as on-highway and off-highway vehicles. The machines may be used in various industries, such as mining, construction, agriculture, and various other industries known in the art. The engine 100 may also be used in various other applications, such as generator sets.

Referring to FIG. 1, an inline type engine is shown as an example for illustration purpose of the present disclosure. It may be contemplated that the engine 100 may be any type of engine such as, for example, a v-type or a rotary type engine. The engine 100 may be run by fuels such as, for example, diesel, gasoline, gaseous fuel, or a combination thereof.

The engine 100 includes a cylinder block 102 defining one or more cylinders 104 therein. The engine 100 further includes a cylinder head (not shown) mounted on the cylinder block 102. The cylinder head may define one or more inlet ports for receiving air within the cylinder 104 and one or more outlet ports for exiting exhaust gas from the cylinder 104. The engine 100 may further include a crankshaft (not shown) rotatably disposed within the cylinder block 102. The crank shaft may be coupled to one or more pistons that may be slidably disposed within the respective cylinders 104. The cylinder block 102 may further include multiple coolant passageways (not shown) for receiving a coolant therethrough for absorbing heat generated during combustion in the cylinder 104. The cylinder block 102 further includes a side wall 110 configured to enclose the crankshaft therein.

The engine 100 further includes an oil sump (not shown) defined by a first component, such as an oil pan 112 and a second component, such as the cylinder block 102. The oil pan 112 is coupled to the side wall 110 of the cylinder block 102. The oil pan 112 is configured to contain oil therein for lubricating various components of the engine 100, such as the crankshaft, camshaft bearings and valve train components. Further, the oil may, in certain instances, assist in the dissipation of heat generated by the engine 100. In an example, the oil may absorb heat from various components including, but not limited to, the crankshaft, camshaft bearings, valve train components and piston jets before returning to the oil pan 112. The oil may be maintained at certain level within the oil pan 112 for lubricating various components of the engine 100 via various types of lubrication system such as, for example, a splash system and a pressure system. Various components of the lubrication system, such as an oil pump, an oil filter and an oil strainer may be disposed within the oil pan 112.

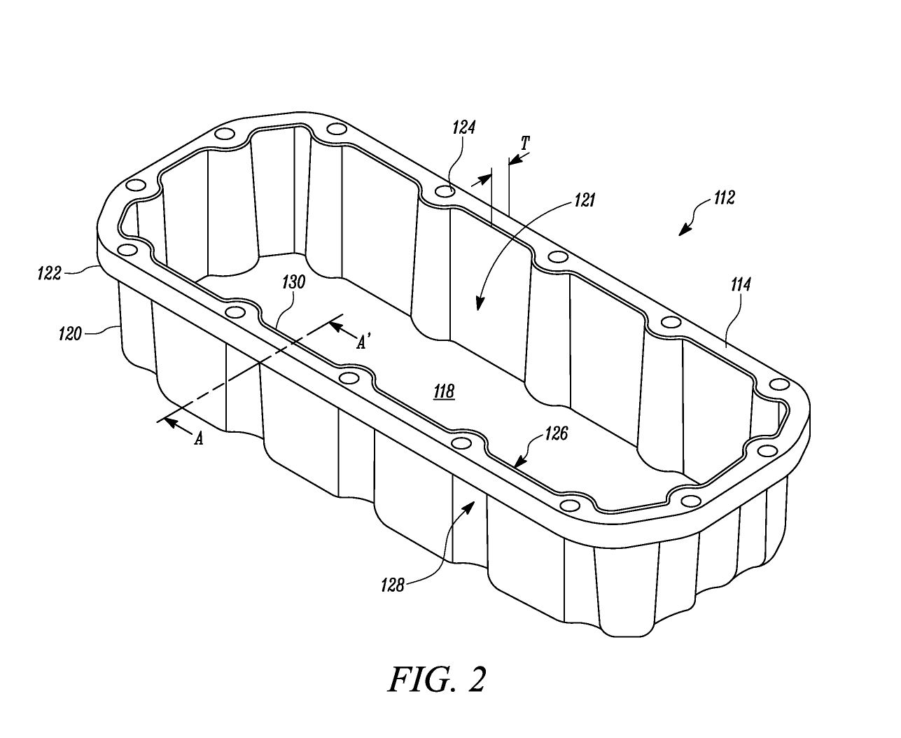

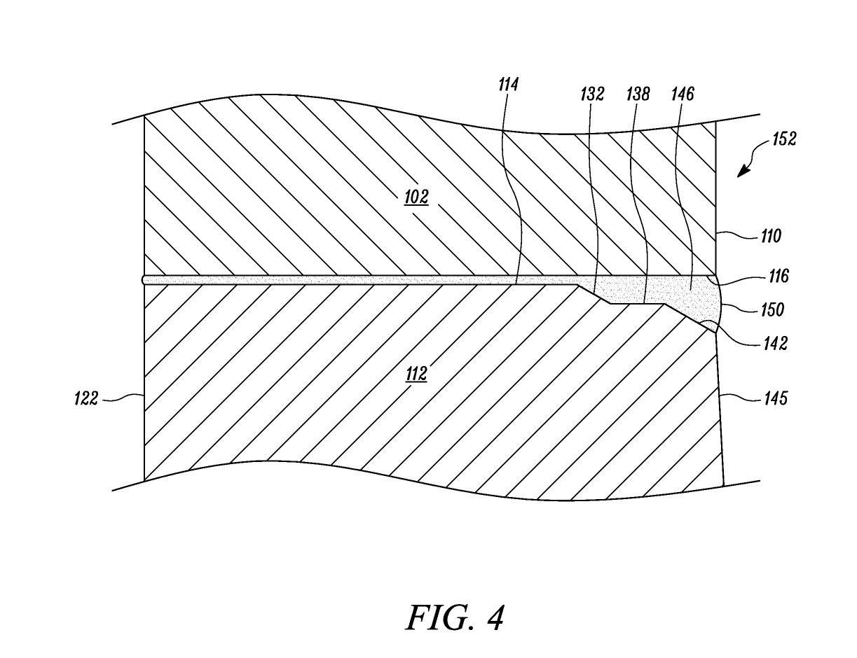

FIG. 2 is a perspective view of the oil pan 112, according to an embodiment of the present disclosure. The oil pan 112 includes a mating surface 114 configured to abut an abutment surface 116 (shown in FIG. 4) defined by the side wall 110 of the cylinder block 102. The oil pan 112 may be coupled to the cylinder block 102 via a number of fastening members (not shown).

The oil pan 112 further includes a bottom member 118 and a side member 120 extending from the bottom member 118 annularly. The bottom member 118 and the side member 120 of the oil pan 112 are together configured to define an interior space 121. The interior space 121 is configured to contain oil therein for lubricating various components of the engine 100. The side member 120 further includes a flange portion 122 configured to be coupled with the side wall 110 of the cylinder block 102. The flange portion 122 is defined along a periphery of the side member 120. The flange portion 122 defines the mating surface 114 thereon. The mating surface 114 is configured to be coupled with the abutment surface 116 of the side wall 110 of the cylinder block 102. The flange portion 122 further includes a number of holes 124 configured to receive the fastening members therethrough. The side wall 110 of the cylinder block 102 may also include a number of holes corresponding to the number of holes 124 to engage with the fastening members. The flange portion 122 further includes an inner periphery 126 and an outer periphery 128. The flange portion 122 may have a thickness “T” defined between the inner periphery 126 and the outer periphery 128. The thickness “T” of the flange portion 122 may vary along the periphery of the side member 120.

The mating surface 114 includes a sealing face 130 defined adjacent to the inner periphery 126 of the flange portion 122. In another embodiment, the sealing face 130 may be defined adjacent to the outer periphery 128 of the flange portion 122. In other embodiments, the sealing face 130 may be defined adjacent to both the inner periphery 126 and the outer periphery 128 of the flange portion 122.

The oil pan 112 may be formed through a molding process. Further, the sealing face 130 may also be integrally formed during the molding process. The mating surface 114 may be machined to abut the abutment surface 116 of the cylinder block 102. In an example, the oil pan 112 may be made from cast iron or cast aluminum. In another example, the oil pan 112 may be made from a metal sheet through a fabrication process or a stamping process. In various examples, the oil pan 112 may be made from metals or alloys via a manufacturing method known in the art.

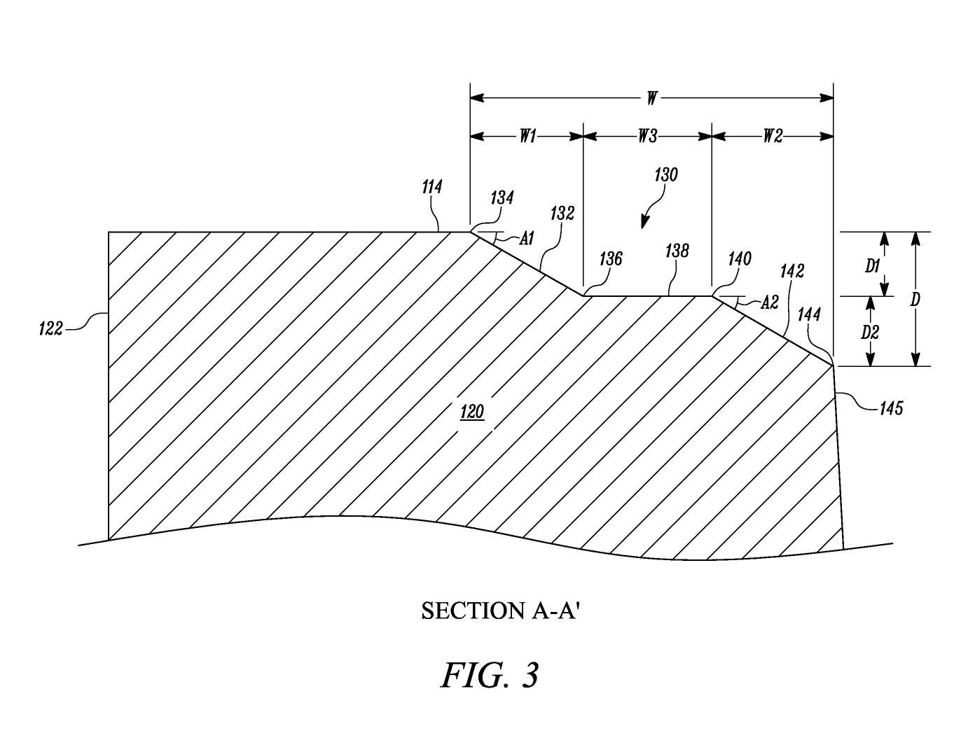

FIG. 3 is a sectional view of the oil pan 112 taken along line A-A′ of FIG. 2, according to an embodiment of the present disclosure. Referring to FIG. 3, a cross-section of the sealing face 130 is shown for illustration purpose of the present disclosure. The sealing face 130 includes a first slant surface 132 extending inwardly from a top edge 134 of the mating surface 114 to a first inner edge 136 of the oil pan 112. The first slant surface 132 is further disposed at a first angle “A1” with respect to the mating surface 114. In one embodiment, the first angle “A1” may lie approximately between 30 and 45 degrees relative to the mating surface 114. In another embodiment, the first angle “A1” may lie approximately between 35 and 40 degrees relative to the mating surface 114. In yet another embodiment, the first angle “A1” may be approximately 45 degrees relative to the mating surface 114.

In an embodiment, the first slant surface 132 may define a first width “W1” extending between the top edge 134 of the mating surface 114 and the first inner edge 136 along a plane defined by the mating surface 114. Further, the first slant surface 132 may define a first depth “D1” with respect to the mating surface 114 based on the first angle “A1” and the first width “W1”.

The sealing face 130 further includes a straight surface 138 extending from the first slant surface 132. The straight surface 138 is provided between the first inner edge 136 and a second inner edge 140 of the oil pan 112. In the illustrated embodiment, the straight surface 138 is parallel to the mating surface 114. However, it may be contemplated that the straight surface 138 may be at an angle with respect to the mating surface 114. The angle of the straight surface 138 may be defined within a predefined tolerance limit. The predefined tolerance limit may be defined based on manufacturing specification.

The sealing face 130 further includes a second slant surface 142 extending inwardly from the straight surface 138 to an innermost edge 144 of the oil pan 112. The innermost edge 144 of the oil pan 112 communicates with the interior space 121 (see FIG. 2) defined within the oil pan 112. Further, the innermost edge 144 may connect to an inner surface 145 of the oil pan 112. In another embodiment, the innermost edge 144 may be defined adjacent to the inner surface 145 of the oil pan 112 such that a straight surface may be defined between the inner surface 145 and the innermost edge 144. The second slant surface 142 is disposed at a second angle “A2” with respect to the straight surface 138. In one embodiment, the second angle “A2” may lie approximately between 30 and 45 degrees relative to the straight surface 138. In another embodiment, the second angle “A2” may lie approximately between 35 and 40 degrees relative to the straight surface 138. In yet another embodiment, the second angle “A2” may be approximately 45 degrees relative to the straight surface 138.

The second slant surface 142 may define a second width “W2” extending between the second inner edge 140 and the innermost edge 144 of the oil pan 112 along the plane defined by the mating surface 114. Further, the second slant surface 142 may define a second depth “D2” with respect to the straight surface 138 based on the second angle “A2” and the second width “W2”.

In one embodiment, the second slant surface 142 may be parallel to the first slant surface 132. In such case, the first angle “A1” of the first slant surface 132 and the second angle “A2” of the second slant surface 142 is the same. However, in other embodiments, the second angle “A2” of the second slant surface 142 may be different from the first angle “A1” of the first slant surface 132.

The first slant surface 132, the straight surface 138 and the second slant surface 142 are configured to define a space 146 (see FIG. 4) with reference to the abutment surface 116 of the cylinder block 102. The space 146 is configured to receive a sealant 150 (see FIG. 4) therein. In an example, the sealant 150 may be a LOCTITE gasket sealant. In various examples, the sealant 150 may be any type of liquid sealant known in the art.

The straight surface 138 may define a width “W3” extending between the first inner edge 136 and the second inner edge 140 of the oil pan 112. The width “W3” of the straight surface 138 lies in a range approximately between 5% and 50% of a width “W” of the sealing face 130 defined between the top edge 134 of the mating surface 114 and the innermost edge 144 of the oil pan 112. The first width “W1”, the second width “W2” and the width “W3” may be determined based on various parameters of the oil pan 112 including, but not limited to, a thickness of the side member 120 of the oil pan 112, the thickness “T” of the flange portion 122, a volume of the space 146 to be defined with respect to the abutment surface 116 of the cylinder block 102, and a type of the sealant 150. The width “W” includes the first width “W1”, the second width “W2” and the width “W3”. Further, the width “W” of the sealing face 130 lies approximately in a range between 1 mm and 7 mm.

Further, the sealing face 130 may have a depth “D” defined vertically between the mating surface 114 and the innermost edge 144 of the oil pan 112. The depth “D” includes the first depth “D1” and the second depth “D2”. Further, the depth “D” of the sealing face 130 lies approximately in a range between 0.5 mm and 3 mm.

In an embodiment, a ratio of the first depth “D1” of the first slant surface 132 defined between the top edge 134 and the first inner edge 136 to the second depth “D2” of the second slant surface 142 defined between the second inner edge 140 and the innermost edge 144 is 1:1. However, it may be contemplated that the ratio of the first depth “D1” to the second depth “D2” may differ based on the first width “W1” and the first angle “A1” of the first slant surface 132 and the second width “W2” and the second angle “A2” of the second slant surface 142. In various embodiments, the ratio may be determined based on various parameters of the oil pan 112 such as the thickness of the side member 120 of the oil pan 112, the thickness “T” of the flange portion 122, the volume of the space 146, and the type of the sealant 150.

FIG. 4 is a sectional view of a portion of a sealing assembly 152 defined between the oil pan 112 and the cylinder block 102 of the engine 100, according to an embodiment of the present disclosure. The sealing assembly 152 includes the mating surface 114 defined on the oil pan 112 and the abutment surface 116 defined on the side wall 110 of the cylinder block 102. The sealing assembly 152 further includes the sealing face 130 defined at the mating surface 114 of the oil pan 112. The cylinder block 102 is coupled with the oil pan 112 such that the abutment surface 116 of the side wall 110 of the cylinder block 102 may contact the mating surface 114 of the oil pan 112. The abutment surface 116 is configured to be in a contacting relationship with the mating surface 114 of the oil pan 112.

The sealing assembly 152 further includes the sealant 150 that is received between the abutment surface 116 of the cylinder block 102, and the mating surface 114 and the sealing face 130 of the oil pan 112. The sealant 150 may form an impermeable barrier between the cylinder block 102 and the oil pan 112. Thus the sealant 150 may prevent any leakage of fluids through a clearance defined between the mating surface 114 of the oil pan 112 and the abutment surface 116 of the cylinder block 102. Apart from acting as a gasket sealant, the sealant 150 may also act as a gasket adhesive to facilitate coupling between the oil pan 112 and the cylinder block 102.

### INDUSTRIAL APPLICABILITY

The present disclosure relates to the sealing face 130 defined at the mating surface 114 of the oil pan 112. The sealing face 130 of the present disclosure may be provided on the first component or the second component that is to be coupled with the first component. According to the illustrated embodiment, the first component is the oil pan 112 and the second component is the cylinder block 102. The sealing face 130 is defined on the first component such that the sealant 150 is received into the space 146 defined by the sealing face 130 in order to provide a fluid tight coupling between the first component and the second component.

During an assembly of the oil pan 112 with the cylinder block 102, the sealant 150 is deposited on the mating surface 114 of the oil pan 112 before disposing the cylinder block 102 on the oil pan 112. In an example, the sealant 150 may be deposited by a tool member on the mating surface 114. In an embodiment, the tool member may be controlled to deposit the sealant 150 on the mating surface 114 adjacent to the top edge 134 of the sealing face 130. In other embodiments, the tool member may be controlled to deposit the sealant 150 at any location of the mating surface 114 along a periphery of the sealing face 130. During the deposition, some quantity of the sealant 150 deposited on the mating surface 114 may flow down to the first slant surface 132, the straight surface 138 and the second slant surface 142.

The cylinder block 102 may be further coupled with the oil pan 112 via the fastening members. Torque applied on the fastening members may cause a portion of an amount of the sealant 150 remain in the mating surface 114 to flow down to the space 146 defined by the first slant surface 132, the straight surface 138, the second slant surface 142 and the abutment surface 116 of the cylinder block 102. It may also be contemplated that a self weight of the cylinder block 102 may also cause the sealant 150 to flow down to the space 146 while disposing the cylinder block 102 on the oil pan 112 before coupling with the oil pan 112 via the fastening members. Thus, the space 146 defined by the sealing face 130 adjacent to the inner periphery 126 of the oil pan 112 is filled with the sealant 150. Further, the sealant 150 is completely filled between the abutment surface 116 of the cylinder block 102 and the mating surface 114 and the sealing face 130 of the oil pan 112 to provide a fluid tight coupling between the cylinder block 102 and the oil pan 112.

The space 146 defined by the sealing face 130 between the oil pan 112 and the cylinder block 102 may accommodate a larger amount of the sealant 150 compared to known sealing structures. Further, the sealant 150 received into the space 146 may provide fluid tight coupling between the cylinder block 102 and the oil pan 112 even after thermal expansion of the oil pan 112 and the cylinder block 102. During operation of the engine 100, the oil pan 112 and the cylinder block 102 may be exposed to high temperature such that the oil pan 112 and the cylinder block 102 may undergo thermal expansion. The extent of thermal expansion may vary based on type of material of the oil pan 112 and the cylinder block 102 as the different material may have different thermal expansion coefficients. Further, the space 146 defined by the sealing face 130 may accommodate the thermal expansion of the oil pan 112 and the cylinder block 102, and continue to provide a fluid tight coupling. Further, the space 146 defined by the sealing face 130 provides a fluid tight joint for components that experience vibration. Also, as the sealing face 130 is formed during molding of the oil pan 112, an additional machining process is not required for forming the sealing face 130. Hence, overall manufacturing cost of the oil pan 112 may be reduced due to less tooling cost and machining cost.

It may be contemplated that although the sealing assembly 152 is described in relation to the oil pan 112 and the cylinder block 102 of the engine 100, the sealing face 130 may be utilized in other components used for forming a fluid container or a fluid line structures, such as pipe lines or other engine covers such as valve covers. Dimensions of the first slant surface 132, the straight surface 138 and the second slant surface 142 of the sealing face 130 may vary based on various applications. Further, the sealing face 130 may include more than two slant surfaces based on the applications.

While aspects of the present disclosure have been particularly shown and described with reference to the embodiments above, it will be understood by those skilled in the art that various additional embodiments may be contemplated by the modification of the disclosed systems and methods without departing from the spirit and scope of what is disclosed. Such embodiments should be understood to fall within the scope of the present disclosure as determined based upon the claims and any equivalents thereof.

What is claimed is:

1. A sealing face defined at a mating surface of a component, the sealing face having a cross-section comprising:
a first slant surface extending inwardly from a top edge of the mating surface to a first inner edge of the component, the first slant surface being disposed at a first angle with respect to the mating surface;
a straight surface extending from the first slant surface, wherein the straight surface is provided between the first inner edge and a second inner edge of the component; and
a second slant surface extending inwardly from the straight surface to an innermost edge of the component, the second slant surface being disposed at a second angle with respect to the straight surface.

2. The sealing face of claim 1, wherein the first slant surface, the straight surface and the second slant surface define a space with respect to an abutment surface of another component, and wherein the space is configured to receive a sealant therein.

3. The sealing face of claim 2, wherein the space is further configured to allow thermal expansion of the sealing face defined at the mating surface of the component and the abutment surface of another component, and wherein the components are made from materials having different thermal expansion coefficients.

4. The sealing face of claim 1, wherein the first angle lies between 30 and 45 degrees relative to the mating surface.

5. The sealing face of claim 1, wherein the straight surface is parallel to the mating surface.

6. The sealing face of claim 1, wherein the second angle lies between 30 and 45 degrees relative to the straight surface.

7. The sealing face of claim 1, wherein a width of the straight surface lies in a range between 5% and 50% of a width of the sealing face.

8. The sealing face of claim 7, wherein the width of the sealing face lies in a range between 1 mm and 7 mm.

9. The sealing face of claim 1, wherein the first slant surface is parallel to the second slant surface.

10. The sealing face of claim 1, wherein a depth of the sealing face lies in a range between 0.5 mm and 3 mm.

11. The sealing face of claim 1, wherein a ratio of a depth of the first inner edge from the top edge, to a depth of the inner most edge from the second inner edge is 1:1.

12. The sealing face of claim 1, wherein the innermost edge of the component communicates with an interior space defined within the component.

13. The sealing face of claim 1, wherein the top edge and the mating surface of the component are configured to couple to another component.

14. A sealing assembly defined between a first component and a second component, the sealing assembly comprising:
a mating surface defined on the first component;
an abutment surface defined on the second component, wherein the abutment surface is in a contacting relationship and coupled to the mating surface;
a sealing face defined at the mating surface of the first component, the sealing face having a cross-section comprising:
a first slant surface extending inwardly from a top edge of the mating surface to a first inner edge of the first component, the first slant surface being disposed at a first angle with respect to the mating surface;
a straight surface extending from the first slant surface, wherein the straight surface is provided between the first inner edge and a second inner edge of the first component; and
a second slant surface extending inwardly from the straight surface to an innermost edge of the first component, the second slant surface being disposed at a second angle with respect to the straight surface; and
a sealant provided in a space defined between the first slant surface, the straight surface, the second slant surface and the abutment surface.

15. The sealing structure of claim 14, wherein the first angle lies between 30 and 45 degrees relative to the mating surface.

16. The sealing structure of claim 14, wherein second angle lies between 30 and 45 degrees relative to the straight surface.

17. A sealing face for an oil pan, the sealing face having a cross-section comprising:
a first slant surface extending inwardly from a top edge of a mating surface of the oil pan to a first inner edge of the oil pan, the first slant surface being disposed at a first angle with respect to the mating surface;
a straight surface extending from the first slant surface, wherein the straight surface is provided between the first inner edge and a second inner edge of the oil pan; and
a second slant surface extending inwardly from the straight surface to an innermost edge of the oil pan, the second slant surface being disposed at a second angle with respect to the straight surface.

18. The sealing face of claim 17, wherein the first slant surface, the straight surface and the second slant surface are configured to define a space, and wherein the space is configured to receive a sealant therein.

19. The sealing face of claim 17, wherein the first angle lies between 30 and 45 degrees relative to the mating surface.

20. The sealing face of claim 17, wherein the second angle lies between 30 and 45 degrees relative to the straight surface.
